(19) United States
(12) Patent Application Publication
(10) Pub. No.: US 2025/0257909 A1
(43) Pub. Date: Aug. 14, 2025

(54) CRYOGENIC COOLING APPARATUS AND RELATED METHODS

(71) Applicant: ISTHMUS CRYOTECH, INC., Minneapolis, MN (US)

(72) Inventors: James Robert Dutton, Hudson, WI (US); Michael John Brusseau, Center City, MN (US); Mary Elizabeth Donnelly, Saint Louis Park, MN (US); Brad James Traeger, Eden Prairie, MN (US); Ross Kent Dunbar, Bloomington, MN (US); Alexandre Terentiev, Frisco, TX (US)

(21) Appl. No.: 18/855,203

(22) PCT Filed: Apr. 7, 2023
(86) PCT No.: PCT/US2023/065534

§ 371 Date: Oct. 8, 2024

Related U.S. Application Data
(60) Provisional application No. 63/328,938, filed on Apr. 8, 2022.

(51) Int. Cl. F25B 9/10

(52) U.S. Cl. CPC F25B 9/10

(57) ABSTRACT

An apparatus for cooling one or more samples includes a cryostat with a first wall forming an inner chamber with an opening for receiving the one or more samples. A second wall forms an outer chamber adapted to insulate the inner chamber and a channel leading to the opening of the inner chamber. A seal selectively seals the opening to the inner chamber, and a cryocooler thermally links to the inner chamber, such as by way of a flexible strap. The inner chamber may entirely surround the outer chamber, and yet via the channel allow for the removal of the one or more samples from the inner chamber while maintaining the evacuated outer chamber. The inner chamber may also be fully contained within the outer chamber, which may be evacuated. Related methods are also disclosed.

This application claims the benefit of U.S. Provisional Patent Application Ser. No. 63/328,938, filed Apr. 8, 2022, the disclosure of which is incorporated herein by reference.

### TECHNICAL FIELD

This document relates generally to the cooling arts and, more particularly, to a cryogenic cooling apparatus and related methods.

### BACKGROUND

Cell and gene therapies form one of the fastest growing sectors of the biopharmaceutical industry. Such therapies lie at the cutting edge of current medical research by endeavoring to achieve curative, rather than palliative, patient outcomes. Despite the tremendous promise of these new therapies, corresponding manufacturing processes and operational logistics needed for successful application present multiple challenges in need of redress to realize full market potential.

For example, reliable, controlled cryogenic storage is one of the key requirements for standardized manufacturing, transport and distribution of such cell or gene therapy products. Many current storage devices suffer from a significant deficiency by requiring the use of liquid cryogens to maintain the required cold conditions for storage or transport of samples or products used to implement such therapies. Such liquid cryogens are costly to acquire, store, and maintain. Moreover, many locations or facilities that could utilize the above-mentioned therapies, as well as others in the supply chain for associated products, lack the ability to supply or otherwise manage liquid cryogens. These issues render storage and transport devices employing such liquid cryogens difficult, if not impossible, to use successfully.

In the past, others have proposed devices that avoid the need for liquid cryogens for cryogenic storage. Known devices suffer from significant complexity and cost, making use for cryogenic storage highly impractical. Such devices also lack the efficiency needed to make longer term, reliable storage and/or transport under cryogenic conditions a reality at a reasonable cost and without undue effort.

Accordingly, a need exists for a cryogenic cooling apparatus that may simplify the storage of products in need of cooling, such as cell therapy products. By affording reliable cooling without the use of liquid cryogens, the apparatus would not only reduce the associated cost, but also considerably reduce the risk of degradation caused by uncontrolled or inhomogeneous cryogenic temperature regimes during manufacture, transport and storage of such products. The elimination of liquid cryogen further facilitates portability and thus transport to locations without access to liquid cryogens, such as for example local healthcare clinics, veterinary offices, rural locations and in developing countries. Overall, a significant improvement in the ability to achieve reliable transport of such products would be realized in an easier and more efficient manner.

### SUMMARY

The present disclosure proposes a cryogenic cooling apparatus useful to simplify the logistics of storing and/or transporting of one or more samples in need of cooling, such as cell and gene therapy products. The apparatus would provide reliable cooling without the use of liquid cryogens, and thus be useful to reduce the costs and improve the efficacy of the storage/transport of such sample(s) or product(s), while considerably reducing the risk of degradation that might result from uncontrolled or inhomogeneous cryogenic temperature regimes during manufacture, transport and storage. The provision of reliable and efficient cooling and the elimination of liquid cryogen further facilitates portability and thus the ability to transport about, within or to locations without access to liquid cryogens, such as for example local healthcare clinics, veterinary offices, rural locations and in developing countries. Overall, the apparatus realizes a significant improvement in the ability to achieve reliable storage and transport of such products in an easier and more efficient manner and, consequently may serve to advance significantly the aims of the biopharmaceutical industry in achieving curative and thus desirable patient outcomes.

According to one aspect of the disclosure, an apparatus is provided for cooling one or more samples. The apparatus comprises a cryostat including a first wall forming an inner chamber with an opening for receiving the one or more samples and a second wall forming an outer chamber adapted to insulate the inner chamber and a channel leading to the opening of the inner chamber. A seal selectively seals the opening to the inner chamber, and a cryocooler thermally links to the inner chamber for maintaining cold (cryogenic) conditions therein.

In some embodiments, a thermal link between the cryostat and the inner chamber may serve to maintain the samples under the desired cryogenic conditions. In one example, the thermal link comprises a flexible thermal strap extending from a cold end of the cryocooler to the first wall forming the inner chamber, but could instead be established by direct contact between a cold end of the cryocooler and the inner chamber. In one example, the thermal link may connect to a heat sink associated with the first wall, whether flexible or otherwise as disclosed herein.

In some embodiments, the seal comprises a removable plug for insertion into the channel. An open end of the channel may be formed in a vertical portion of the second wall forming the outer chamber. This channel may be bounded on all sides except open ends by a continuous portion of this second wall. The removable plug may include an insulated interior chamber, may be connect to a first door for selectively closing the opening to the inner chamber. The first door may comprise an outer door, and a second, interior door may selectively close the opening to the inner chamber in concert with the removable plug and/or the outer door.

The inner chamber may comprise a non-circular cross-section in a horizontal plane. The outer chamber may be sealed and evacuated. The outer chamber may include an insulating material comprising glass, such as glass beads (which may be spherical or irregular in shape).

A support for supporting the inner chamber relative to the outer chamber may be provided. The support may take the form of a connector for connecting the first wall to the second wall. The connector may be adapted to minimize thermal transfer from the first wall to the second wall. In any embodiment, the connector may comprise a foam material, and/or may comprise a multilayer insulation (MLI) reflective material, such as a blanket.

Various optional features may also be included in some or all disclosed embodiments. For instance, a controller may be provided for controlling the cryocooler based on a sensed temperature within the cryostat. A getter may be associated with the outer chamber in order to facilitate maintaining an evacuated state thereof. In some embodiments, a purge valve may be associated with the inner chamber. The inner chamber may comprise one or more shelves for receiving the one or more samples. In any embodiment, the apparatus may include a mobile stand, such as to allow for transporting the one or more samples under cryogenic conditions about a facility, or otherwise from one location to another (possibly under portable (battery) power).

In some embodiments, the outer chamber may connect to a vacuum pump, which may be portable to facilitate transporting the cryostat. The inner chamber may be fully contained within the outer chamber. The inner chamber may be partially formed by a removable lid including the seal for sealing with the first wall. The outer chamber may be partially formed by a removable lid including the seal for sealing with the second wall.

According to a further aspect of the disclosure, an apparatus is for cooling one or more samples. The apparatus includes a cryostat having a first wall forming an inner chamber with an opening for receiving the one or more samples and a second wall forming an outer chamber adapted to insulate the inner chamber, the outer chamber adapted to maintain an evacuated state when the one or more samples are passed through the opening. A cryocooler thermally links to the inner chamber, and a seal selectively seals the opening to the inner chamber. The seal may comprise one or more movable doors, a removable plug, or both, for selectively allowing access to the sample(s) in the inner chamber.

According to yet another aspect of the disclosure, an apparatus for cooling one or more samples is provided. The apparatus comprises a cryostat including an inner wall forming an inner chamber having an opening for receiving the one or more samples. The inner chamber is formed with a non-circular cross-section in a horizontal plane, and a cryocooler is for cooling the inner chamber.

Still a further aspect of the disclosure pertains to an apparatus is for cooling one or more samples. The apparatus comprises a cryostat including a first wall forming an inner chamber with an opening for receiving the one or more samples and a second wall forming an outer chamber adapted to insulate the inner chamber and forming a channel leading to the opening of the inner chamber. A seal selectively seals the opening to the inner chamber, and a cryocooler connects to the inner chamber by way of a flexible thermal link.

This disclosure also pertains to an apparatus for cooling one or more samples, such as under cryogenic conditions. The apparatus comprises a cryostat including a first wall forming an inner chamber with an opening for receiving the one or more samples and one or more supports for supporting the samples therein, the cryostat further including a second wall forming an outer chamber adapted to insulate the inner chamber. A seal selectively seals the opening to the inner chamber. A cryocooler connects to the inner chamber by a flexible thermal link. In some embodiments, the one or more supports comprise shelves for supporting the one or more samples.

Yet a further aspect of the disclosure pertains to an apparatus for cooling one or more samples. The apparatus comprises a cryostat including a first wall forming an inner chamber with an opening for receiving the one or more samples and a second wall forming an evacuated outer chamber fully surrounding the inner chamber. A cryocooler is for cooling the inner chamber.

In some embodiments, the inner chamber is partially formed by a removable lid including a seal for sealing with the first wall. The outer chamber may also be partially formed by a removable lid including a seal for sealing with the second wall. The outer chamber may be connected to a vacuum pump for maintaining an evacuated state thereof.

This disclosure also pertains to a method for cooling one or more samples. The method comprises providing a cryostat including a first wall forming an inner chamber having the one or more samples sealed therein and a second wall forming an outer chamber adapted to insulate the inner chamber and forming a channel leading to the opening of the inner chamber. The method further comprises cryogenically cooling the inner chamber. In one example, the method further includes the step of inserting a removable plug through the channel. The method may still further include the step of transporting the cryostat.

A further aspect of this disclosure pertains to a method for cooling one or more samples. The method comprises providing a cryostat including an inner chamber with the one or more samples maintained under cryogenic conditions and an evacuated outer chamber for insulating the inner chamber. The method further comprises removing the one or more samples to the inner chamber while maintaining the evacuated outer chamber.

### BRIEF DESCRIPTION OF THE DRAWING FIGURES

The above and further advantages of the concepts discussed in the present disclosure may be better understood by referring to the following description in conjunction with the accompanying drawings in which:

FIG. 1 is a schematic view of a first embodiment of a cooling apparatus;

FIG. 1A is a schematic view of one portion of the cooling apparatus of the first embodiment;

FIG. 1A is a schematic view of another portion of the cooling apparatus of the first embodiment;

FIG. 2 is a perspective view of a second embodiment of the cooling apparatus;

FIG. 3 is another perspective view of the second embodiment of the cooling apparatus;

FIG. 3A is a partially cross-sectional perspective view of the second embodiment of the cooling apparatus;

FIG. 3B is an end view of the second embodiment of the cooling apparatus;

FIG. 3C is a partially cross-sectional side view of the second embodiment of the cooling apparatus;

FIG. 3D is another partially cross-sectional perspective view of the second embodiment of the cooling apparatus;

FIG. 4 is a partially cross-sectional perspective view of an alternate version of the second embodiment of the cooling apparatus; and

FIG. 5 is a schematic view of a third embodiment of the cooling apparatus.

The dimensions of some of the elements may be exaggerated relative to other elements for clarity or several physical components may be included in one functional block or element. Further, sometimes reference numerals may be repeated among the drawings to indicate corresponding or analogous elements. Moreover, some of the blocks depicted in the drawings may be combined into a single function.

### DETAILED DESCRIPTION

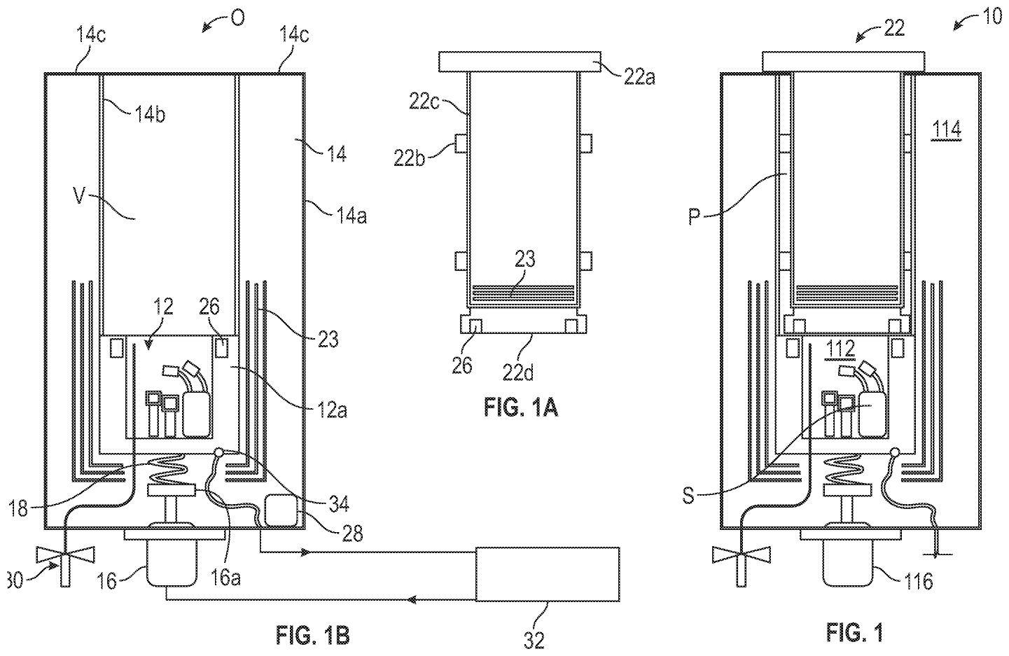

This disclosure pertains generally to a cooling apparatus, such as for cooling one or more products, which may be termed samples herein, and related methods. In one exemplary embodiment, and with reference to the schematic illustrations of FIGS. 1, 1A, and 1B, the cooling apparatus comprises a cryostat 10. In the illustrated version, the cryostat 10 comprises an inner chamber 12 including an inner wall 12a with an opening O for receiving one or more products or samples S in need of cooling. The inner chamber 12 may take any form, but is typically a cuboid-like structure with a generally hollow interior (save for support structures for the one or more samples, if present) and an open end forming the opening O.

The cryostat 10 further includes an outer chamber 14. This outer chamber 14 may be formed at least in partly by an outer wall 14a and serves to insulate the inner chamber 12. In connection with an associated inner wall 14b, the outer chamber 14 also forms a channel serving as an entryway or passage leading to the inner chamber 12. In one example, this channel may be considered to form a vestibule V continuously surrounded by the inner wall 14b of the outer chamber 14 except along the open end, and leading from the ambient environment external to the cryostat 10 to the opening O of the inner chamber 12.

The outer chamber 14 may surround the inner chamber 12 on all sides except for the location of the opening O. On the lateral sides of the inner chamber 12 in the orientation shown in FIGS. 1, 1A, and 1B, the outer chamber 14 is annular, and thus forms an annulus between the outer wall 14a and the inner wall 12a forming the inner chamber 12 to provide insulating function. At the lower or bottom end of the inner chamber 12, the outer wall 14a is spaced from the inner wall 14a to provide a space or gap to achieve insulating function.

To enhance the insulating effect, the outer chamber 14 may be sealed and evacuated (permanently and passively, or selectively and actively, such as if connected to a vacuum pump, as outlined in the following description). Consequently, minimal transmission of thermal energy from an ambient environment outside of the cryostat 10 to the inner chamber 12 results. As outlined further in the description that follows, insulative materials, such as one or more of glass beads, foam, multilayer insulation materials or the like, may also be provided within the outer chamber 14 or otherwise associated with the cryostat 10 to enhance the insulating effect achieved.

The inner chamber 12 may be cooled or otherwise maintained in a state colder than the ambient environment (such as a cryogenic state) by way of an associated cooler. In the illustrated embodiment, the cooler comprises a refrigerator adapted to reach cryogenic temperatures, such as from approximately −150° C. to approximately −196° C. For purposes of this disclosure, such temperatures may be achieved using one or more cryocoolers 16, such as a Stirling cycle cryocooler available from Sunpower, Inc., as the refrigerator(s). Other suitable forms of mechanical refrigerators capable of achieving cryogenic temperatures are known.

This cryocooler 16 may be located external to the cryostat 10, and connected to the inner chamber 12 by way of a thermal connection or link. In one example, the thermal link comprises a strap in the form of a flexible thermal link 18, as illustrated schematically. This flexible thermal link 18 serves to connect a cold end 16a of the cryocooler 16 with the inner wall 12a in order to provide cooling effect and thereby cool the contents of the inner chamber 12, such as the one or more samples. The flexible link 18 avoids introducing significant stress into the cold end 16a of the cryocooler 16, which may be sensitive to such stress.

The inner chamber 12 may be sealed from the ambient environment. This may be achieved, for example, by providing a seal in the form of a movable door, cover or lid for covering the opening O and permitting selective access to the contents of the inner chamber 12. In the illustrated example, this door comprises a removable plug 22. This plug 22 may be adapted to form a sealing engagement with an inner wall 14b internal to the cryostat 10, which partially forms the outer chamber 14 and the vestibule V. The plug 22 may include an oversized cover 22a for at least partially covering an entrance end of the vestibule V, and possibly engaging with an end wall 14c partially forming the outer chamber 14.

In one particular example, the engagement between the inner wall 14b and the plug 22 may be established by one or more spacers 22b, which are considered optional. If present, these spacer(s) 22b serve to create one or more spaces or pockets P between the adjacent inner wall 14b of the outer chamber 14 and the plug 22. These pocket(s) P may contain an insulating material, including possibly a gas, and thus minimize thermal transfer between the inner wall 14a and the plug 22. The spacer(s) 22b may connect to the plug 22, such as to a body portion 22c for occupying the vestibule V when inserted therein, or may connect to the inner wall 14b, or both.

The body portion 22c may be adapted to insulate further the inner chamber 12 from the ambient environment. This may involve providing the body portion 22c with a hollow interior or portion thereof, which may be evacuated and/or provided with an insulating material to minimize thermal transfer. The body portion 22c may also include a distal end 22d formed of a thermally conductive solid material, such as metal, to further insulate the inner chamber 12.

In use, and as can be understood from FIG. 1, the one or more samples S may be located in the inner chamber 12 by passing through vestibule V and opening O, and supported by the inner wall 12a thereof. Inner chamber 12 may be maintained under low temperature or cryogenic conditions by way of the thermal link to the cryocooler 16. The door, such as plug 22, may then be positioned in the cryostat 10, such as within vestibule V, possibly with an innermost or distal end of the plug body portion 22c engaging the inner wall 12a forming the inner chamber 12 and sealing the same.

In this position, the cover 22a of the plug 22 sealing the passageway or channel forming the vestibule V from the ambient environment, the pockets P if present, the insulative nature of the body portion 22c, and the insulative outer chamber 14, together help to prevent heat transfer from the inner chamber 12 and maintain the sample(s) S therein under the desired cold (cryogenic) conditions. The sample(s) S may be inserted or removed from the inner chamber 12 via the opening O without interrupting or disturbing the evacuated nature of the outer chamber 14, which although connected to the inner chamber 12 may be independent of it in terms of any fluid communication. The presence of a single opening O to the inner chamber 12 lessens the degree to which thermal losses may result when the door is opened to access the sample(s) S therein.

Various optional features may also form part of the cryostat 10. For example, one or more shields 23 for shielding against radiation may be provided, such as in the outer chamber 14, the body portion 22c of the plug 22, or at both locations. The shield(s) 23 may comprise a multilayer insulation (MLI) reflective material, such as a blanket, which may include multiple reflective layers of thin sheeting.

Furthermore, the plug 22 may also be adapted to form a releasable coupling with the cryostat 10, such as by positioning one or more opposing permanent magnets 26 between the plug 22 and the inner wall 12a, for example. One or more getters 28 may be provided in the outer chamber 14 to aid in maintaining the evacuated condition thereof. A purge valve 30 may be associated with the inner chamber 12 for introducing a gas, such as nitrogen, for environmental (e.g. moisture) control.

A controller 32 may also be associated with the cryostat 10 for controlling one or more aspects or parameters of the operation. For example, the controller 32 may be associated with a temperature sensor, such as a thermocouple 34, connected to the inner chamber 12 or the wall 12a thereof for providing a signal indicative of temperature. The sensor signal representative of temperature may be transmitted to the controller 32, which may then automatically regulate the operation of the cooler, such as for example cryocooler 16, to maintain the desired conditions within the chamber 12 and thus the sample(s) in a cold state.

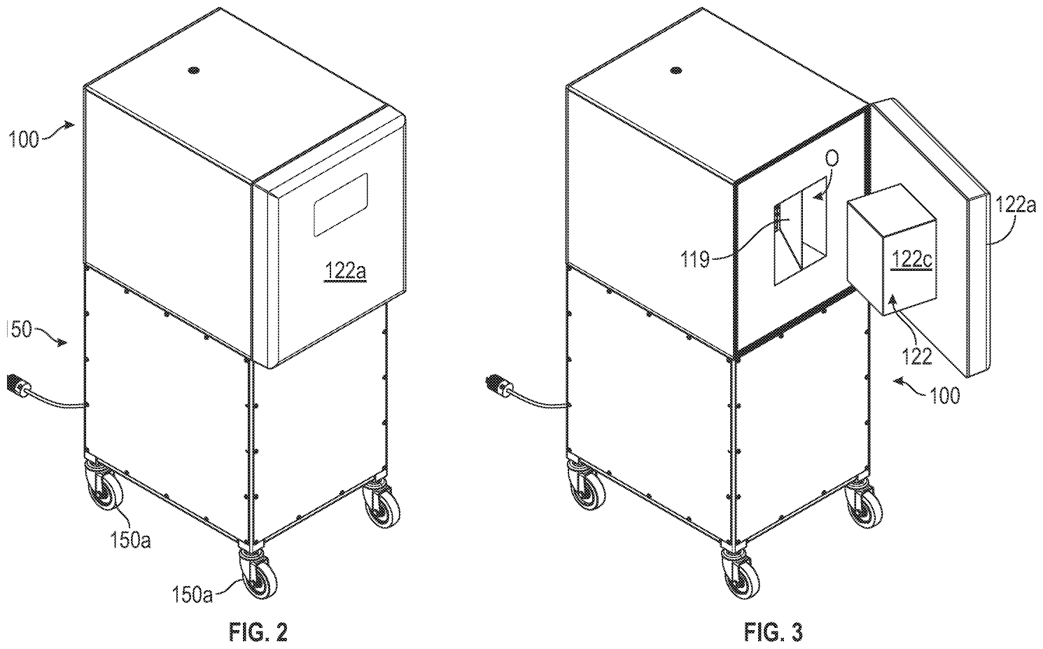

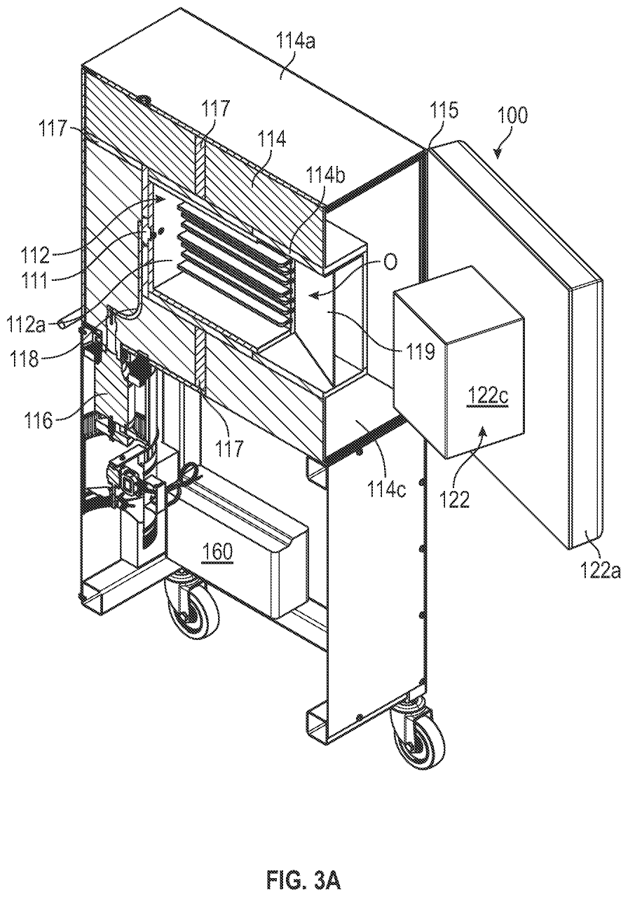

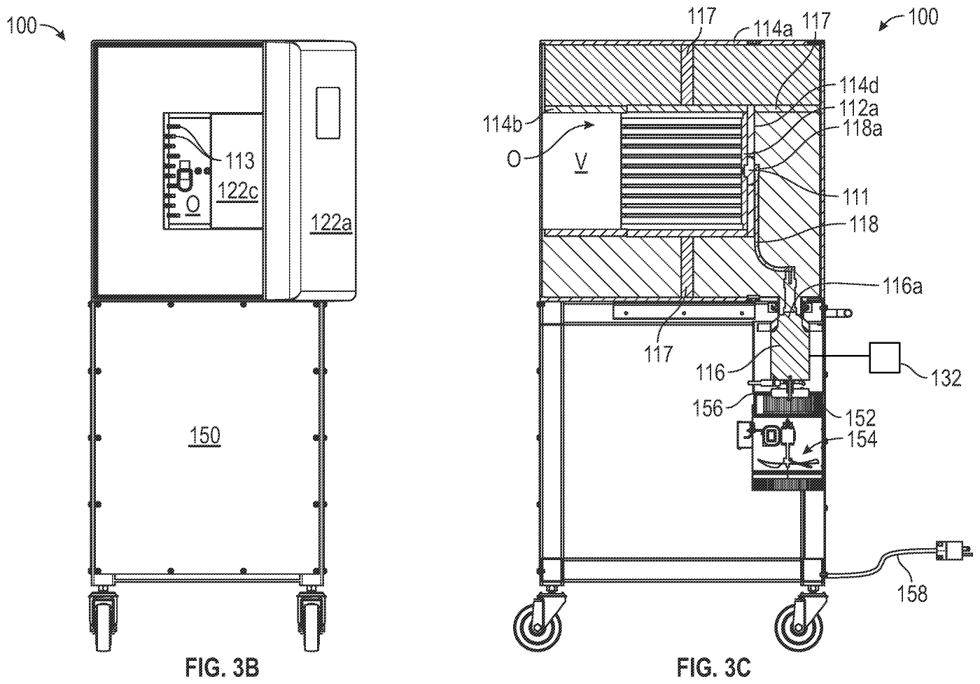

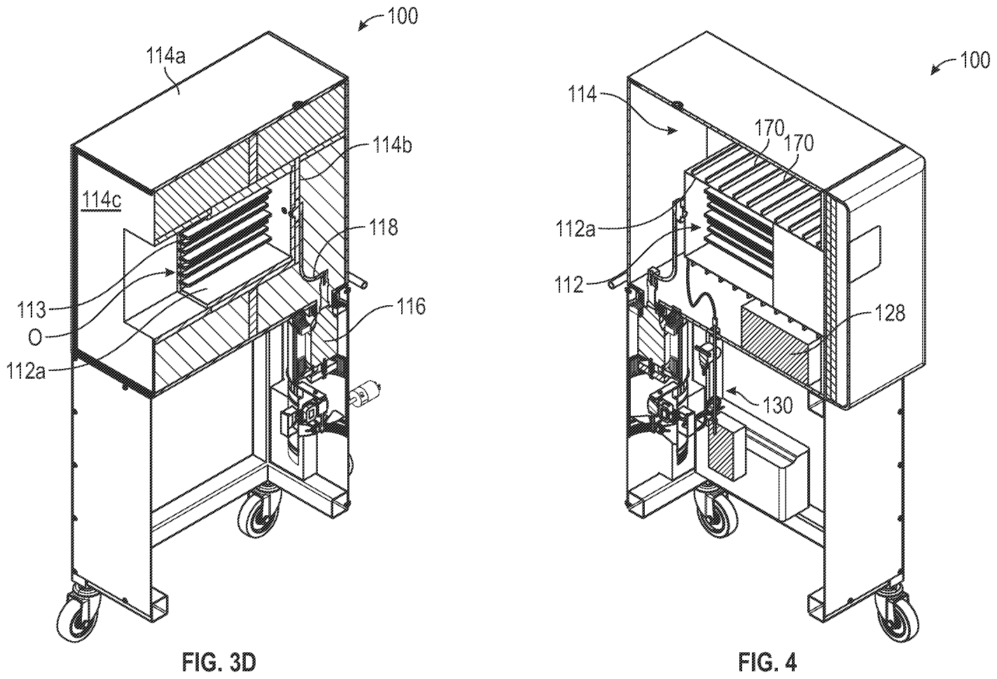

Turning now to FIGS. 2, 3, 3A, 3B, 3C, and 3D, another exemplary embodiment of a cooling apparatus comprising a cryostat 100 is shown. This version of the cryostat 100 comprises an inner chamber 112 including an inner wall 112a with an opening O for receiving one or more samples (not shown) in need of cooling. The cryostat 100 further includes an outer chamber 114 formed at least in partly by an outer wall 114a for insulating the inner chamber 112 and an inner wall 114b for partially forming a channel serving as an entryway or passage to the opening O of the inner chamber 112.

As with cryostat 10, this channel may be considered to form a hollow, tubular structure forming a vestibule V continuously surrounded by the inner wall 114b of the outer chamber 114, except along the open end formed in a vertical end wall 114c also partially forming the outer chamber 114. The vestibule V thus forms a passage leading from the ambient environment to the opening O of the inner chamber 112. The outer chamber 114 may surround the inner chamber 112 on all sides except for the location of the opening O and vestibule V, similar to the first embodiment of cryostat 10. As in the first embodiment, the inner wall 114b of the cryostat 100 partially forms the outer chamber 114 and also part of the vestibule V proximate to the opening O to the inner chamber 112.

As with the first embodiment, the inner chamber 112 may be cooled or maintained in a state that is colder than the ambient environment (such as a cryogenic state). This functionality may be achieved by way of an associated cooler. This cooler may take the form of a refrigerator, such as a cryocooler 116 (and while only one is shown, more than one refrigerator or cryocooler could be included in any disclosed embodiment).

The cryocooler 116 may be located external to the cryostat 100. The connection between the cryocooler 116 and the inner chamber 112 to establish thermal communication may be by way of a thermal connection or link. In one example, the thermal link 118 comprises a flexible thermal link 118 or strap, which may pass through an opening in the outer wall 114a and extend within the outer chamber 114 to communicate thermally with the inner chamber 112.

More specifically, this thermal link 118 may serve to connect a cold end 116a of the cryocooler 116 with the inner wall 112a in order to provide cooling effect and thereby cool the contents of the inner chamber 112, such as one or more sample(s). However, the thermal link or connection could alternatively be provided by direct contact between the cold end 116a of the cryocooler 116 and the inner chamber 112 (as in the third embodiment). In the illustrated embodiment, a distal end 118a of the thermal link 118 inserts into an aperture in a rear inner wall 114d partially forming the outer chamber 114. This distal end 118a may connect with a heat sink 111 for increasing the surface area and degree of thermal communication. This ensures that thermal communication is established, and the cooling effect is achieved for the inner chamber 112 in an efficient and effective manner.

As perhaps best shown in FIGS. 3C and 3D, the outer chamber 114 may be formed of an inner wall 114b surrounding the inner chamber 112, which as outlined below may be cuboid in shape. This inner wall 114b may partially overlap and contact the inner wall 112a forming the inner chamber 112, and connect to the outer wall 114a partially forming the periphery of outer chamber 114 by one or more supports in the form of connectors 117. These connector(s) 117 may extend within the outer chamber 114, which again may be evacuated and/or insulated. The connector(s) 117 may be adapted to minimize thermal transfer from the inner wall 114b to the outer wall 114a, such as by taking the form of a latticework, reticulated structure, or other arrangement to achieve the desired dual functions of lending structural support and enhanced rigidity while minimizing thermal losses via direct transmission due to the connection thus formed.

To provide the insulating effect, the outer chamber 114 may be evacuated (permanently or actively, such as if connected to a vacuum pump), such that the transmission of thermal energy from an ambient environment outside of the cryostat 100 to the inner chamber 112 is minimized. As noted above, the outer chamber 114 may further include an insulating material to enhance the insulating effect achieved. For example, the insulating material provided within the outer chamber 114 may comprise an insulator, such as glass and, in particular, glass beads or microspheres, which may substantially fill the space therein. In addition to evacuation of the outer chamber 114, the presence of an insulative material therein (e.g., beads, shielding, foam, or combinations thereof) serves to further aid in reducing the transmission of thermal energy between the inner chamber 112 and the ambient environment.

With reference to FIGS. 3 and 3A, the inner chamber 112 may be selectively sealed from the ambient environment. This may be achieved by providing a seal in the form of a movable door for covering and sealing the opening O and permitting selective access to the contents of the inner chamber 112. In the illustrated example, this door comprises a removable plug 122. This plug 122 may be adapted to form a sealing engagement with the inner wall 114b partially forming the outer chamber 114 and bounding the vestibule V.

The plug 122 may be connected to an oversized cover 122a also forming the door. This cover 122a at least partially covers and seals an entrance end of the vestibule V, and possibly engages the vertical end wall 114c partially forming the outer chamber 114. In this second embodiment, the door (including plug 122) is secured to the cryostat 100 by a connection, such as a hinge 115, which allows the door to swing between a closed position (FIG. 2) and an open position (compare FIG. 2 with FIG. 3, for example).

The plug 122 includes a body portion 122c for occupying the vestibule V when inserted therein. This body portion 122c may be adapted to insulate the inner chamber 112 from the ambient environment, such as having an interior that is hollow and evacuated or provided with an insulating material. The body portion 122c may also include a distal end formed of a thermally conductive material so as further aid in insulating the inner chamber 112.

In use, and with reference to FIGS. 3B, 3C, and 3D, the one or more samples may be located in the inner chamber 112, which may be maintained under low temperature or cryogenic conditions by way of the thermal link to the cryocooler 116. In order to support the sample(s), the inner chamber 112 may be provided with one or more supports, such as in the form of pairs of inwardly directed, opposed ledges 113 of varying width that form shelves. These ledges 113 may be provided on opposing sides of the inner wall 112a and thus serve to receive the one or more samples, which may be provided on or in carriers, such as trays or containers, including bags, pouches, vials, or the like. The different widths of ledges 113 may receive different sizes or shapes of carriers and, thus, allow for the cryostat 100 to accommodate a variety of typical substrates on which sample(s) in need of cooling or cold storage are provided by manufacturers, especially those in the biopharmaceutical industry.

Once the samples are in position, the seal, such as door, may then seal the vestibule V, such as by inserting the plug 122 therein. When fully inserted, an innermost end of the plug body portion 122c may partially engage the inner wall 112a forming the inner chamber 112 (unless an intervening structure is present, as outlined further below) and seal the opening O. In this position, the cover 122a of the plug 122 seals the entrance to the passageway or channel forming the vestibule V from the ambient environment, and together with the insulative outer chamber 114, help to prevent heat transfer from the inner chamber 112 and maintain the sample(s) therein under the desired cold conditions achieved by the associated cooler, such as cryocooler 116. The sample(s) may be inserted or removed without interrupting or disturbing the evacuated nature of the outer chamber 114, which although connected to the inner chamber 112 may be independent of it in terms of any fluid communication.

FIGS. 3 and 3 A perhaps best illustrate that a second seal in the form of an interior door 119 may optionally be provided for closing the open end of the inner chamber 112 when the first door, or plug 122 is removed. This second door 119 may be mounted for relative movement between an open position for accessing the contents (sample(s)) of the inner chamber 112 and a closed position to seal the opening O. The movement may involve swinging the second door 119 about a hinged connection with the inner wall 112a, or else sliding the door 119 along tracks or guides (such as in the form of a garage-style door with hinged, interconnected panels that may articulate or fold). In the closed position, this inner door 112 lies between the inner chamber 112 and the distal end of the plug 122, and can be opened when the plug 122 is withdrawn from the vestibule V.

In the illustrated version, and with reference to FIG. 2, the cryocooler 116 is shown as being connected directly to the cryostat 100, such as along the outer wall 114a of chamber 114. In the particular version illustrated, the cryocooler 116 depends from the cryostat 100. Both the cryostat 100 and the cryocooler 116 may be supported by a stand 150. The stand 150 may include wheels 150a to facilitate mobility and transport, and thus may form a mobile cart.

With reference to FIG. 4, the cryocooler 116 may be associated with one or more heat transfer enhancements or structures, such as a heat sink 152. In the illustrated version, the heat sink 152 is associated with the cryocooler 116 opposite the cold end thereof. A fan 154 may circulate air to provide cooling for the cryocooler 116 and help to maximize efficiency. The cryocooler 116 may also be associated with a tubular or hollow enclosure 156, with the fan 154 arranged for exhausting heat therefrom (that is, away from the cryocooler 116, and at a sufficient distance to avoid meaningfully influencing the ambient temperature in terms of impacting the desired thermal regulation of cryostat to maintain the samples sufficiently cold).

From FIGS. 3A and 3D, it can be understood that the inner chamber 112 may be generally hollow and non-circular in cross-section, or otherwise not in the form of a cylindrical structure. In the illustrated embodiment of the cryostat 100, and in the orientation shown, the chamber 112 has a non-circular, generally square and generally constant cross-section in a vertical plane, and a non-circular, generally rectangular and generally constant cross-section in a horizontal plane, which thus forms a cuboid (but with one end open). Likewise, the entire cryostat 100 may have a similar construction, with the outer wall 114 thus forming a cuboid, box-like structure. The same shape attributes may be applied to other disclosed embodiments, such as cryostat 10 (or cryostat 200 as outlined further in the following description).

It can also be appreciated that the cryostat 100 as illustrated is arranged to present the opening O for accessing the samples in the inner chamber 112 along or in a vertical sidewall, such as wall 114c partially forming the outer chamber 114c, as contrasted with a top wall or a bottom wall. This facilitates insertion of the sample(s) into the chamber 112 in a horizontal, rather than a vertical direction. Such may be considered easier and more efficient for the user in a typical application of the cryostat 100, and more conventional in terms of the manner in which permanent cryogenic storage may be provided in a fixed unit. In such case, the door including the plug 122 (and/or door 119) may be adapted to be removed from a position sealing the opening O in a generally horizontal plane as well, which may be facilitated by the presence of the hinge 115 to allow for swinging movement between the open and closed positions.

The cryostat 100 may be adapted to operate using AC mains power, and may include a plug 158 for powering the electrical components thereof, such as the cryocooler 116 and controller 132. The controller 132 may function to regulate the cryocooler 116 in the manner outlined above, including with feedback from one or more sensors (e.g., similar to thermocouple 34) for sensing the temperature of the inner chamber 112 and/or other associated portions of the cryostat 100. Alternatively or additionally, the cryostat 100 may be associated with a portable power device, such as a battery 160 carried by the stand 150. The battery 160 may serve to power the cryostat 100 primarily, or may serve as a secondary or backup source in the event of a power failure or interruption.

The controller 132 may optionally be associated with an input device for inputting information for control of the cryostat 100 and an output device for displaying information relating to operating conditions of the cryostat. The output device may comprise a display including a graphical user interface for displaying one or more parameters associated with the operation of the cryostat 100, such as for example: (1) temperature (absolute or deviation/range), (2) time of storage of sample(s), (3) an indication that the proper temperature is provided for storage, (4) a notification of failure or other notifications of issues of concern to the end user (such as for example, battery life and time to depletion to a particular level (e.g., 25% or less), (5) system failure(s), (6) power outage/switch to battery backup, (7) door closed, (8) door properly sealed, and/or (9) a potential tip over/fall indicator. Any or all of the notifications may be provided visually by way of a display, audibly by way of a speaker, alarm, or like device, or both, as may be desired.

The cryostat 100 may also include a locator, such as a GPS tracker. This locator may be used to facilitate locating the cryostat 100 during transportation or during storage. The controller 132 may be programmed to require a security code to change any settings for operating the cryostat 100. By way of the input device, the controller 132 may allow the user to indicate the identity of the samples stored in the inner chamber 112 and possibly their location.

Similar to those incorporated above optionally into the first embodiment of cryostat 10, various optional modifications may be incorporated into the second embodiment of cryostat 100. For example, as shown in FIG. 4, a getter 128 may be provided in association with the outer chamber 114 to facilitate maintenance of evacuated conditions. The inner chamber 112 may also be associated with a purge valve 130 to supply dry air or nitrogen thereto to reduce moisture.

In FIG. 4, it can also be seen that supports in the form of spaced isothermal structural supports, such as in the form of bands 170, may be optionally provided. These bands 170 may extend along or surround the inner wall 112a between the inner chamber 112 and the outer chamber 114 of cryostat 100. These bands 170 provide additional support for the inner chamber 112, while minimizing heat transfer and wall thickness. This may be in addition to any or all of the insulative materials also described herein for use in facilitating maintaining the inner chamber 112 under cryogenic conditions.

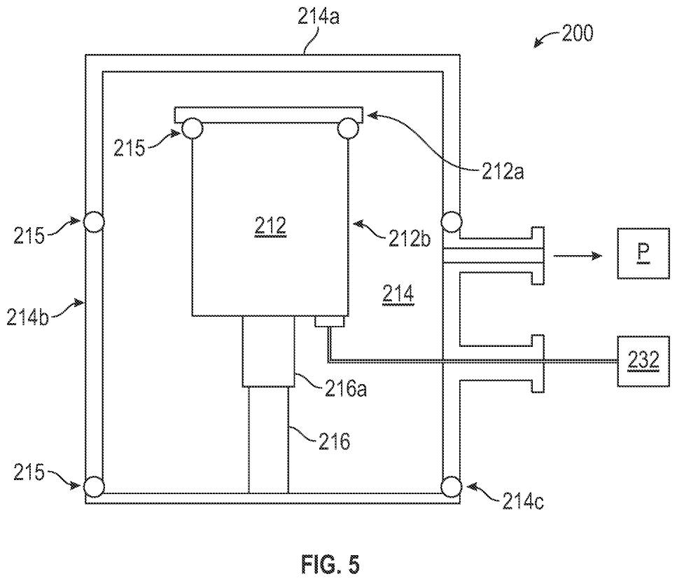

With reference now to FIG. 5, a third embodiment of a cryostat 200 is illustrated. In this version, the inner chamber 212 is entirely or fully enclosed within the outer chamber 214, which again may be evacuated (such as by a vacuum pump P, which may be applied to any disclosed embodiment). The inner chamber 212 includes a seal in the form of a removable door or lid 212a connected to an inner wall 212b that lies entirely within the outer chamber 214, and thus seals an opening to the inner chamber 212. As can be appreciated, this lid 212a sealing the chamber 212 is fully enclosed by the outer chamber 214.

The outer chamber 214 also includes a seal in the form of a removable door or lid 214a, which connects to and form part of an outer wall 214b to form an enclosure and thus seals an opening to the outer chamber 214. The sidewall of the outer chamber 214 may form a channel around the inner chamber 212, and a bottom wall 214c of the outer chamber 214 may support the inner chamber 212. The lid 214a of the outer chamber 214 may be connected to the remainder of the outer wall 214b by way of a vacuum seal 215. A similar vacuum seal 213 may be provided between the lid 212a and inner wall 212b forming the inner chamber 212.

A cooler or refrigerator in the form of a cryocooler 216 may also be provided. The cold end 216a of the cryocooler 216 may connect directly to the wall 212b of the inner chamber 212 to form a thermal link so that cold is transferred thereto to maintain any samples therein under cryogenic conditions, or may form the thermal link by connecting indirectly (such as by way of a flexible strap, as previously described). The cryocooler 216 may be connected to a power source (not shown), as described above. The cryocooler 216 may also communicate with an external controller 232 by way of wired or wireless connection to regulate the temperature achieved.

In use, the outer chamber 214 may be opened via lid 214a to expose the opening and thus the inner chamber 212. The lid 212a of inner chamber 212 may also be opened to expose the opening thereof, and one or more samples may be positioned in the inner chamber 212, which may then be sealed by replacing lid 212a. The lid 214a may be repositioned to seal outer chamber 214, and a vacuum established therein using vacuum pump P once the seal is formed.

The cryocooler 216 may then be used to achieve low or cryogenic temperatures in the inner chamber 212, thus maintaining the samples in the desired cold state for storage or transport. When retrieval of the samples is desired, the vacuum may be released, which may involve the use of suitable valving (not shown) for relief, and the lids 212a, 214a opened to access to the samples in the inner chamber 212. The process may then be repeated as necessary or desired.

The materials used to form various components of the cryostats 10, 100, 200 may be optimized to achieve the optimal ability to maintain the sample(s) in inner chamber 12, 112, 212 under cryogenic conditions during storage and/or transport. For example, the structural walls of the cryostat 10, 100, 200, such as any of walls forming all or part of the inner or outer chambers 12, 14, 112, 114, 212, 214 may comprise strong, lightweight materials, such as metal, and aluminum in particular, but could comprise polymer materials, such as foam, resin, or the like. Any such walls may comprise or include a multilayer insulation (MLI) reflective material alone or in addition to the above-mentioned materials. The internal supports, such as connector(s) 117 or band(s) 170, if present, may likewise comprise similar materials, with a preference for the use of foam adapted for use under cryogenic conditions, such as the CRYOFOAM brand of phenolic resin distributed by Thermahold Solutions of Charlotte, North Carolina. If present, the glass beads or microspheres may be those available from 3M, and/or may comprise aerogel, perlite, or like insulative materials. To maximize thermal conductivity and heat transfer, the heat sink 111, 152 may comprise metal, such as copper or copper alloys (e.g., brass) or similar materials, and any fittings or connections may comprise similar materials. As noted above, to reduce the radiation and increase the ability to maintain cryogenic temperatures, a multilayer insulation (MLI) material, such as a reflective blanket, may be formed, such as by inserting multiple reflective layers of thin sheeting in the cryostat 10, 100, 200.

Summarizing, this disclosure may be considered to relate to the following items:
1. An apparatus for cooling one or more samples, comprising:
   a cryostat including a first wall forming an inner chamber with an opening for receiving the one or more samples and a second wall forming an outer chamber adapted to insulate the inner chamber and forming a channel leading to the opening of the inner chamber;
   a seal for selectively sealing the opening to the inner chamber; and
   a cryocooler thermally linked to the inner chamber.
2. The apparatus of item 1, further including a thermal link linking the cryostat and the inner chamber.
3. The apparatus of item 2, wherein the thermal link comprises a flexible thermal link extending from a cold end of the cryocooler to the first wall forming the inner chamber.
4. The apparatus of item 1 or item 2, wherein the thermal link connects to a heat sink associated with the first wall.
5. The apparatus of any of items 1-4, wherein the seal comprises a removable plug for insertion into the channel.
6. The apparatus of any of items 1-5, wherein an open end of the channel is formed in a vertical portion of the second wall.
7. The apparatus of any of items 1-6, wherein the channel is bounded by a continuous portion of the second wall.
8. The apparatus of any of items 5-7, wherein the removable plug includes an insulated interior chamber.
9. The apparatus of any of items 5-8, further including a first door for selectively closing the opening to the inner chamber, the first door connected to the removable plug.
10. The apparatus of item 9, further including a second door for selectively closing the opening to the inner chamber.
11. The apparatus of any of items 1-10, wherein the inner chamber comprises a non-circular cross-section in a horizontal plane.
12. The apparatus of any of items 1-11, wherein the outer chamber is sealed and evacuated.
13. The apparatus of any of items 1-12, wherein the outer chamber includes an insulating material comprising glass.
14. The apparatus of item 13, wherein the glass comprises glass beads.
15. The apparatus of any of items 1-14, further including a connector for connecting the first wall to the second wall, the connector adapted to minimize thermal transfer from the first wall to the second wall.
16. The apparatus of item 15, wherein the connector comprises a foam material.
17. The apparatus of any of items 1-16, further including a controller for controlling the cryocooler based on a sensed temperature within the cryostat.
18. The apparatus of any of items 1-17, further including a getter associated with the outer chamber.
19. The apparatus of any of items 1-18, wherein one end of the cryocooler directly contacts the first wall.
20. The apparatus of any of items 1-19, further including a purge valve associated with the inner chamber.
21. The apparatus of any of items 1-20, wherein the inner chamber comprises one or more shelves for receiving the one or more samples.
22. The apparatus of any of items 1-21, wherein the outer chamber is connected to a vacuum pump.
23. The apparatus of any of items 1-22, wherein the inner chamber is within the outer chamber.
24. The apparatus of any of items 1-23, wherein the inner chamber is partially formed by a removable lid including the seal for sealing with the first wall.
25. The apparatus of any of items 1-14, wherein the outer chamber is partially formed by a removable lid including the seal for sealing with the second wall.
26. A mobile stand including the apparatus of any of items 1-25.
27. An apparatus for cooling one or more samples, comprising:
   a cryostat including a first wall forming an inner chamber with an opening for receiving the one or more samples and a second wall forming an outer chamber adapted to insulate the inner chamber, the outer chamber adapted to maintain an evacuated state when the one or more samples are passed through the opening; and
   a cryocooler thermally linked to the inner chamber.
28. The apparatus of item 27, further including a seal for selectively sealing the opening to the inner chamber.
29. An apparatus for cooling one or more samples, comprising:
   a cryostat including an inner wall forming an inner chamber having an opening for receiving the one or more samples, the inner chamber having a non-circular cross-section in a horizontal plane; and
   a cryocooler for cooling the inner chamber.
30. An apparatus for cooling one or more samples, comprising:
   a cryostat including a first wall forming an inner chamber with an opening for receiving the one or more samples and a second wall forming an outer chamber adapted to insulate the inner chamber;
   a seal for selectively sealing the opening to the inner chamber; and
   a cryocooler connected to the inner chamber by a flexible thermal link.
31. An apparatus for cooling one or more samples, comprising:
   a cryostat including a first wall forming an inner chamber with an opening for receiving the one or more samples and one or more supports for supporting the samples therein, the cryostat further including a second wall forming an outer chamber adapted to insulate the inner chamber;
   a seal for selectively sealing the opening to the inner chamber; and
   a cryocooler thermally linked to the inner chamber.
32. The apparatus of item 31, wherein the one or more supports comprise shelves for supporting the one or more samples.
33. An apparatus for cooling one or more samples, comprising:
   a cryostat including a first wall forming an inner chamber with an opening for receiving the one or more samples and a second wall forming an outer chamber adapted to be evacuated and fully surrounding the inner chamber; and
   a cryocooler for cooling the inner chamber.
34. The apparatus of item 33, wherein the inner chamber is partially formed by a removable lid including a seal for sealing with the first wall.
35. The apparatus of item 33 or item 34, wherein the outer chamber is partially formed by a removable lid including a seal for sealing with the second wall.
36. The apparatus of claim 33, further including a vacuum pump for evacuating the outer chamber.
37. An apparatus for cooling one or more samples, comprising:
   a cryostat including a first wall forming an inner chamber with an opening for receiving the one or more samples and a second wall forming an outer chamber adapted to insulate the inner chamber;
   a first seal for selectively sealing with the first wall;
   a second seal for selectively sealing with the second wall; and
   a cryocooler thermally linked to the inner chamber.
38. The apparatus of item 37, wherein the second wall forms a channel leading to the opening of the inner chamber.
39. The apparatus of claim 37, wherein the outer chamber is adapted to maintain an evacuated state when the one or more samples are passed through the opening.
40. The apparatus of any of items 1-39, further including a multilayer insulation (MLI) reflective blanket in the cryostat.
41. A method for cooling one or more samples, comprising:
   providing a cryostat including a first wall forming an inner chamber having the one or more samples sealed therein and a second wall forming an outer chamber adapted to insulate the inner chamber and forming a channel leading to the opening of the inner chamber; and
   cryogenically cooling the inner chamber.
42. The method of item 40, further including the step of inserting a removable plug through the channel.
43. The method of item 42, further including the step of sealing the opening.
44. A method for cooling one or more samples, comprising:
   providing a cryostat including an inner chamber with the one or more samples maintained under cryogenic conditions and an evacuated outer chamber for insulating the inner chamber; and
   delivering the one or more samples to or from the inner chamber while maintaining the evacuated outer chamber.
45. The method of any of items 40-44, further including the step of transporting the cryostat with the one or more samples under cryogenic conditions.

Although certain inventive concepts have been described in conjunction with specific embodiments, many alternatives, modifications, and variations will be apparent to those skilled in the art. Accordingly, it embraces all such alternatives, modifications, and variations that fall within the spirit and scope of the appended claims. It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

All publications, patents and patent applications mentioned in this specification are herein incorporated in their entirety by reference into the specification, to the same extent as if each individual publication, patent or patent application was specifically and individually indicated as incorporated by reference. The identification of any reference in this application shall not be construed as an admission that such reference is available as prior art to the present disclosure.

As used herein, the following terms have the following meanings:

“A”, “an”, and “the” as used herein refers to both singular and plural referents unless the context clearly dictates otherwise. By way of example, “a compartment” refers to one or more than one compartment.

“About,” “substantially,” or “approximately,” as used herein referring to a measurable value, such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. The value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The foregoing description of various inventive aspects is presented for purposes of illustration. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. An apparatus for cooling one or more samples, comprising:
a cryostat including a first wall forming an inner chamber with an opening for receiving the one or more samples and a second wall forming an outer chamber for insulating the inner chamber and a channel extending to the opening of the inner chamber;
a seal for selectively sealing the opening to the inner chamber; and
a cryocooler thermally linked to the inner chamber.

2. The apparatus of claim 1, further including a thermal link between the cryostat and the inner chamber.

3. The apparatus of claim 2, wherein the thermal link comprises a flexible thermal link extending from a cold end of the cryocooler to the first wall forming the inner chamber.

4. The apparatus of claim 3, wherein the thermal link connects to a heat sink associated with the first wall.

5. The apparatus of claim 1, wherein the seal comprises a removable plug for insertion into the channel.

6. The apparatus of claim 5, wherein an open end of the channel is formed in a vertical portion of the second wall.

7. The apparatus of claim 5, wherein the channel is bounded by a continuous portion of the second wall.

8. The apparatus of claim 5, wherein the removable plug includes an insulated interior chamber.

9. The apparatus of claim 5, further including a first door for selectively closing the opening to the inner chamber, the first door connected to the removable plug.

10. The apparatus of claim 9, further including a second door for selectively closing the opening to the inner chamber.

11. The apparatus of claim 1, wherein the inner chamber comprises a non-circular cross-section in a horizontal plane.

12. The apparatus of claim 1, wherein the outer chamber is sealed and evacuated.

13. The apparatus of claim 1, wherein the outer chamber includes an insulating material comprising glass.

14. The apparatus of claim 13, wherein the glass comprises glass beads.

15. The apparatus of claim 1, further including a connector for connecting the first wall to the second wall, the connector adapted to minimize thermal transfer from the first wall to the second wall.

16. The apparatus of claim 15, wherein the connector comprises a foam material.

17. The apparatus of claim 1, further including a controller for controlling the cryocooler based on a sensed temperature within the cryostat.

18. The apparatus of claim 1, further including a getter associated with the outer chamber.

19. The apparatus of claim 1, wherein one end of the cryocooler directly contacts the first wall.

20. The apparatus of claim 1, further including a purge valve associated with the inner chamber.

21-44. (canceled)
